(19) United States
(12) Patent Application Publication
(10) Pub. No.: US 2005/0278301 A1
(43) Pub. Date: Dec. 15, 2005

(54) System and method for determining an optimized process configuration

(76) Inventors: Maria Guadalupe Castellanos, Sunnyvale, CA (US); Fabio Casati, Palo Alto, CA (US); Ming Chien Shan, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/854,393

(22) Filed: May 26, 2004

(51) Int. Cl. G06F 7/00

(52) U.S. Cl. 707/3

(57) ABSTRACT

The disclosed embodiments relate to a system and method for processing data. The system may involve a process-modeling tool adapted to define a process model, to define mapping from a resource to an activity in the process model, and to define a metric on the process model. Additionally, the system may have a designation module adapted to designate a goal and define constraints. Also included may be a process simulation engine adapted to employ the process model to simulate a process execution based on the process data according to different configurations and to produce process execution data that comprises an expected value for the metric. Further, a process improvement engine may be a component adapted to evaluate the process simulation data produced by the process simulation engine and to provide process improvement data indicative of changes in the expected value of the metric. A search tool may further be included that is adapted to search a configuration space that comprises the process improvement data to determine a prospective configuration that causes the expected value of the metric to approach the goal.

### BACKGROUND OF THE INVENTION

A process may be described as a series of actions, changes, or functions bringing about a result. Processes may be used to define a wide range of activities such as the steps in a computer program, procedures for combining ingredients, manufacturing of an apparatus, and so forth. Further, metrics or process measurements may be defined to allow for process monitoring and data retrieval. Data acquired from a process may be used to improve process performance.

Existing methods for improving the quality of processes require a user to employ different products, manually and independently. Further, existing methods require a user to implement all necessary transformations of data into the various formats dictated by the different products and to generally operate in a piecemeal fashion. For example, a user may be required to manually input various different values for process model parameters into a simulator. Further, the user may be required to repeatedly define the process, to analyze the simulation results, to create custom programs that compute quality indicators from the results, and to perform other similar tasks. Accordingly, the traditional methods of manually improving processes may be cumbersome, complex, lengthy and costly. Further, expert services are generally required to implement such traditional methods.

Techniques regarding process improvement may involve the defining of metrics. Metrics may reflect business goals and include such things as cost, outcome, and duration. It should be noted that goals are the desired values of metrics. Further, service level agreements (SLAs), which are special kinds of goals, inherently have underlying metrics. For example, a duration metric underlies a SLA requiring delivery of items no more than twenty-four hours after an order is placed. The “no more than twenty-four hours” requirement is merely a condition on a duration metric. Existing methods may require a user to define metrics, which may then be used with various different systems in conjunction with manual manipulation of data to develop process improvement information.

### BRIEF DESCRIPTION OF THE DRAWINGS

FIG. 1 is a block diagram illustrating a method of system operation in accordance with embodiments of the present invention;

FIG. 2 is a block diagram representing an exemplary process model in accordance with embodiments of the present invention;

FIG. 3 is a block diagram representing a system in accordance with embodiments of the present invention; and

FIG. 4 is a block diagram illustrating a method in accordance with embodiments of the present invention.

### DETAILED DESCRIPTION OF THE INVENTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention may relate to a methodology for automatic goal-driven improvement of business process quality. Such a method may be driven by certain metrics that reflect business goals. In one embodiment, the invention may comprise a plenary method for analyzing which configuration of the parameters (e.g., number of employees, time requirements, frequency of inspection, and material usage) of a process model achieve business goals. In other words, one embodiment of the present method may be employed to automatically determine the value of a parameter in a process configuration leading to metric values corresponding to business goals.

For example, embodiments of the present invention may address a problem wherein the average duration of a process is below a desired value, and high percentages of instances are exceeding this desired value. Accordingly, it may be desirable to find a best allocation of resources (number of resources of each kind or number of units in each resource pool) that makes this value not exceed the desired value. In one embodiment, a goal may be defined indicating that the value of the total duration metric should not exceed a desired value X. Further, constraints may be added to indicate that such a value should be attained at a cost (another metric) below value Y. Thus, the optimization may indicate that the number of resources of a given kind should be increased by two units. For example, instead of the current use of only three operators, employment of five operators may be necessary to meet the goal.

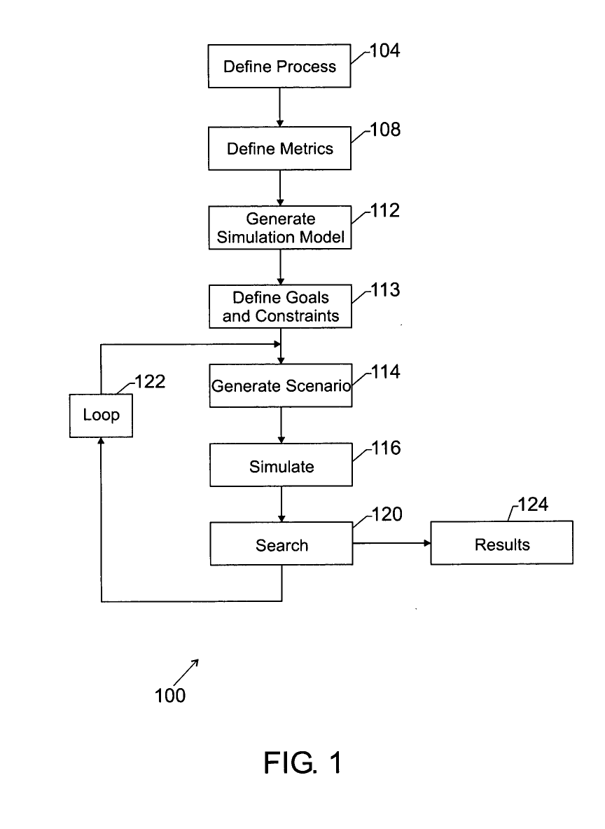

FIG. 1 is a block diagram illustrating a method 100 of system operation in accordance with embodiments of the present invention. Specifically, FIG. 1 gives a general overview of one embodiment of the present invention by illustrating operational steps from the view point of a typical user (e.g., human or automated). Accordingly, in block 104, the user may define a business process model of a business operation. If a process engine already supports the business operation, this step of defining the business process model (block 104) may comprise a simple transfer of information from the process engine. In embodiments without process engine support, a process-modeling tool may be required in order to allow modeling for the sake of monitoring/analyzing operations. After defining the business process model, the user may define metrics on the subject business process (block 108). Then, the user may specify which of those metrics need to be improved (i.e., currently they do not satisfy business goals) by defining for each one whether it needs to be minimized/maximized and optionally a threshold value. In addition, the user may also specify constraints in terms of threshold values of other metrics.

In one embodiment of the presently disclosed method, an assumption is made that the business process (or the portion of the process) being subjected to the disclosed method is instrumented. In other words, it is assumed that instrumentation or the like is in place throughout the process making it possible to have visibility over different activities in the subject process and for some basic information to be logged. For example, an instrumented process may log information such as time stamps indicating the start and end of the process, time stamps for certain steps, indicators for what resources (human or automated) were involved in the execution of an activity, and other such execution data. However, it should be noted that this assumption is not a requirement that a process engine (e.g., a workflow management system that schedules activities and coordinates execution of a process) be employed to support the subject process, although some embodiments may incorporate such a process engine.

After the user provides the definitions in blocks 104 and 108, the system may automatically generate a simulation model for the process (block 112). This simulation model may be generated from the user defined business process model and/or from past execution data, which may have been recorded by the aforementioned instrumentation. Next, in block 113, the user may enter goals and constraints for improving the process and for which the analysis will find the process parameters configuration that meets/satisfies them. In block 114, a scenario may be generated. Such a scenario may correspond to a parameter configuration found by a search procedure. Next, in block 116, the system may simulate several variant scenarios or parameterizations of the process and verify which variant provides the best results in terms of the previously defined goals and subject to the satisfaction of the constraints. The analysis may result in one of more feasible solutions (configuration settings) or none. Block 120 may represent searching a configuration space to determine which configuration (scenario) to try next. A configuration space or configuration search space may comprise all of the combinations of possible values for the different parameters of a process. Further, in accordance with some embodiments of the present invention, the process may proceed in a loop as illustrated by block 122 thus repeating portions of the process for different scenarios. Alternatively, results may be achieved in block 124 without proceeding to or repeating the loop 122. The user or some other entity may view results provided by the system and identify changes (if there was at least one feasible solution) that may improve the subject process (block 122).

In one embodiment, the present method comprises an optimization wherein an optimal or near optimal process configuration that meets the goals may be identified automatically from the space of possible configurations by performing simulations that change aspects of a business process and searching the space of possible configurations in an efficient manner. The method herein described is indifferent or agnostic with respect to the technique used to search the configuration space. In one embodiment the technique may be heuristic-based, for example, hill climbing where the basic idea is to always head towards a state which is better than the current one. There are other techniques which are non-heuristic and exhaustively explore the search space. Optimization constitutes a methodology for a business analyst/manager to identify which changes in parameters of the business process model are required to improve process performance according to criteria given by defined business metrics using various scenarios. Each possible configuration constitutes an scenario. For example, the method may determine that the desired value of a duration metric (i.e., a metric regarding the time required to complete a particular process or portion of a process) is obtained in a given scenario (i.e., if the number of resources of a given type is increased to a certain value). As further illustration, in one example, the new value in process duration may correspond to a reduction in the time required to solve a customer support call. Further, this change in process time may be tracked to a change in the number of customer support representatives allocated to the particular process. In this case, the simulation scenarios may have included a different number of customer support representatives, which may affect the process duration and consequently the number of resolution time SLA violations.

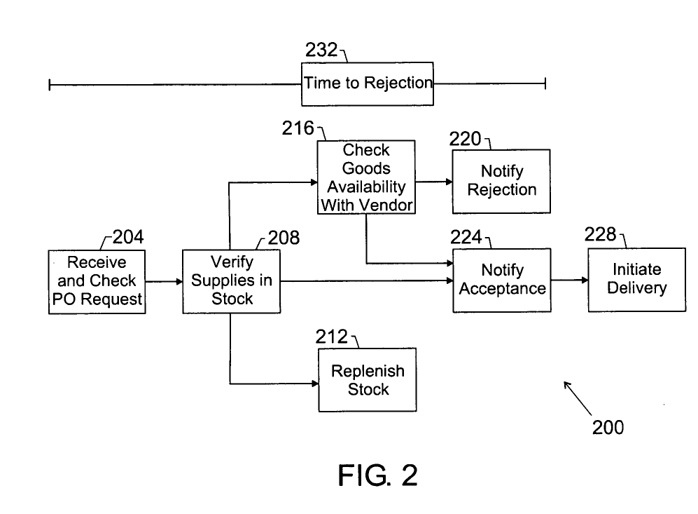

FIG. 2 is a block diagram representing an exemplary process model 200 in accordance with embodiments of the present invention. While other processes could be used, FIG. 2 specifically illustrates a process model 200 for ordering goods. FIG. 2 is merely one example of the process models referred to in the embodiments of the present invention. Further, one skilled in the art would understand that FIG. 2 is merely representative of many process models that are compatible with the present invention.

The process begins at block 204, which represents receiving and checking a purchase order. Block 208 represents verifying that supplies are in stock and block 212 represents replenishing stock levels. If there are not enough supplies in stock, the process may proceed with Block 216 which represents checking availability with a vendor. Depending on whether the vendor has the requested goods available, as determined in block 216, the process model 200 proceeds to either block 220 or 224. Blocks 220 and 224 represent order rejection and order acceptance respectively. Block 228 represents initiation of delivery at the conclusion of the process 200. Finally, block 232 represents a business metric. Specifically, block 232 represents a duration metric for the time required to reject an order for unavailability, where the time starts with reception of the order in block 204.

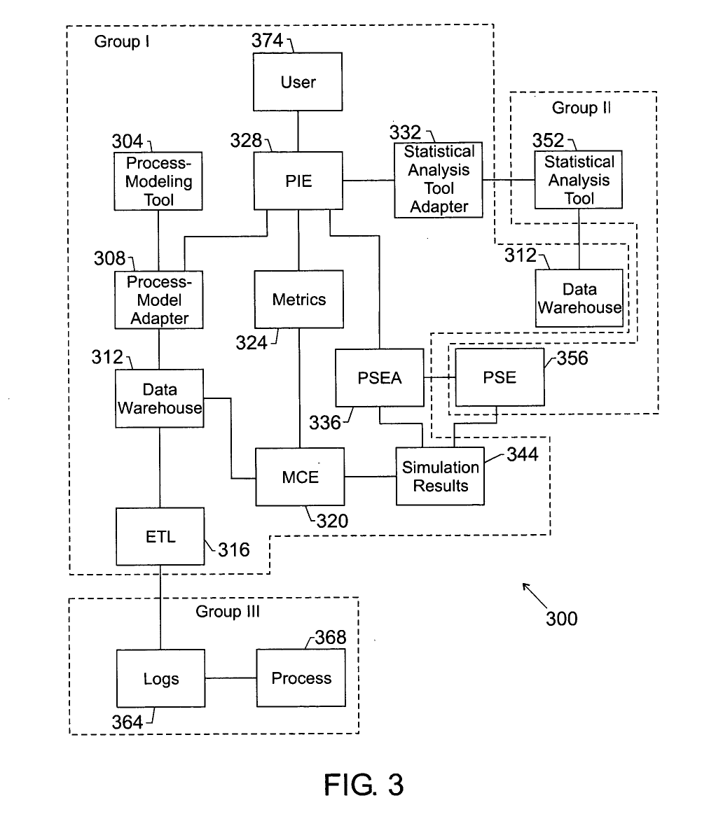

FIG. 3 is a block diagram representing a system 300 in accordance with embodiments of the present invention. Specifically, FIG. 3 represents a general architecture for a process improvement platform incorporated with third party components and a managed environment. Accordingly, FIG. 3 illustrates three component types including process improvement platform (PIP) components, third party components, and managed environment components. These three components are assimilated for illustrative purposes into groups (i.e., Group I, Group II, and Group III). Group I comprises PIP components (blocks 304-344); Group II comprises third party components (blocks 352-356); and Group III comprises managed environment components (blocks 364-368). It should be noted that these groupings are merely for illustrative purposes. One skilled in the art will recognize that the blocks 304-368 may be interchangeable among the groups and that in other embodiments the groupings are different.

As discussed above, blocks 304-344 represent PIP components. Specifically, block 304 represents a process-modeling tool (block 304) which may be operated to define a business process model consisting essentially of a flow diagram of the business process (i.e., nodes connected by acts where nodes represent activities) as illustrated in FIG. 2. The process-modeling tool may also be used to specify the mappings from resource pools to process nodes. For example, activity “receive and check PO request” may be mapped to a pool of employees of type Operator 62. In addition, the user may also define particular metrics associated with the business analysis process by using the process-modeling tool (block 304). Furthermore, in some embodiments the process-modeling tool (block 304) may facilitate monitoring of a process in real time. In one embodiment, the process-modeling tool is comprised by a process engine which manages the process execution and is supplied with data in real time to control the enactment of the activities of the process. In such embodiments, these data may also be used for real time monitoring. However, in other embodiments, the process-modeling tool has a database that receives or is populated with execution data with the only purpose of real time monitoring.

Block 308 represents a process-model adapter, which may operate to translate the process definition established in block 304 into a supported format. Block 312 represents a data warehouse that stores process execution data (e.g., time stamps, starting entity, and resources that performed the activities) collected by business process instrumentation monitoring the actual process (block 368). The data warehouse (block 312) may also store the business process model. Further, the data warehouse (block 312) may store domain descriptions such as the description of an order (e.g., customer name, address, and telephone number) and other relevant data.

Data (block 364) logged during execution of a business operation (block 368) may be imported into the data warehouse (block 312) by an extract transfer load (ETL) tool as illustrated by block 316. Additionally, the process-modeling tool (block 304) database schema may also be populated in accordance with the defined process-modeling tool process and schema semantics. Both loading processes are conceptually analogous. Population of the data warehouse (block 312) schema being different from population of the process modeling tool (block 304) database schema in that monitoring is not the purpose. For example, instead of loading data in a real time fashion during business operation execution, data may be loaded in a batch mode.

Block 320 may represent a PIP component referred to as a metric computation engine (MCE), which computes metric values for the metrics defined in block 304. The MCE (block 320) not only computes values for metrics defined from execution data but also for metrics defined from simulation data as illustrated by blocks 312, 320, and 344. Once the data is stored in the data warehouse (block 312), the MCE (block 320) may compute defined business metrics (block 324). Specifically, the MCE (block 320) may compute metrics that a user designates as associated with the goals of process improvement such as those underlying an SLA.

Block 328 may represent a process improvement engine (PIE), which is also a PIP component. The process improvement engine (block 328) may retrieve data (e.g., process definition, process execution, and metrics data) required for simulation from respective repositories (e.g., process-modeling tool database and datawarehouse). Then, the PIE (block 328) may pass the data to components participating in the simulation. Additionally, the PIE (block 328) may control execution of the components, create scenarios for simulation, and invoke analysis tools (block 352) such as a statistical analysis tool. In one embodiment, the PIE (block 328) invokes a curve fitting tool (block 352) that derives a distribution for different aspects of the subject process to be modeled. For example, the curve fitting tool (block 352) may derive a distribution of an arrival pattern or of an activity duration.

In the illustrated embodiment, the invocation of the curve fitting tool (block 352) passes through a curve fitting or statistical analysis tool adapter (block 332) because it may be desirable to maintain independence between the PIP components and the third party curve fitting tool (block 352), which may comprise curve fitting or other statistical analysis software. In one embodiment, the curve fitting tool (block 352) is a distribution fitter (DF), which finds a probability distribution that best fits a different data set, such as an activity duration or the arrival times of entities to be processed. In another embodiment, the curve fitting adapter (block 332) is a distribution fitter adapter (DFA), which transforms data passed by the PIE (block 328) into the format required by the DF (block 352). Further, the DFA (block 332) may execute the DF (block 352), which may compute a distribution.

After computation of the distribution, the PIE (block 328) may provide the process-modeling tool (block 304) with distribution information. Further, in one embodiment, the PIE (block 328) may provide the process-modeling tool (block 304) with other information requested to a user, such as an indication of resource cost.

The PIE (block 328) may then load the process, now enriched with distributions and other information requested to a user, into a simulator or process simulation engine (PSE) (block 356). The PSE (block 356) may simulate process executions according to different scenarios. Further, in some embodiments, loading the process into the PSE (block 356) comprises employing a process simulator engine adapter (PSEA) (block 336). The PSEA (block 336) may operate to translate the process-modeling tool process definition into a format supported by the simulator (block 356). Additionally, the PSEA (block 336) may operate to transform data passed by the PIE (block 328) into a format required by the PSE (block 356) for simulation. Further, the PSEA (block 336) may operate to transform simulation results into a format required by the MCE (block 320).

Accordingly, the PSE (block 356) may return the simulation results to the PSEA (block 336) to be translated into a format supported by the data warehouse, and depending on implementation it may also write results to a database (block 344). Regardless, the simulation results will generally eventually reside in the data warehouse (block 344). It should be noted that in one embodiment, the PSE or simulator (block 356) provides an execution trace (as part of the simulation results). An execution trace is data indicating event occurrences during the execution of a process. Such an execution trace may be provided by block 356 as needed to compute metrics from the simulation results in addition to the provision of aggregate simulation data. This information may then be used to assess the quality of the simulated process. Further, it should be noted that in some embodiments block 344 represents manipulation of simulation results to resemble real data.

After computing metrics from the traces, the system 300 may repeat certain component functions to test several different simulation scenarios. In particular, the PIE (block 328) includes an algorithm that searches a configuration space to determine which configuration (scenario) to try next according to how well the metric goals have been met by the configurations that have already been tried. It should be noted that the number of potential configurations may be indefinitely large. Accordingly, a non-exhaustive or smart search that employs a heuristic technique may be utilized in some embodiments of the present invention. Once the maximum number of scenarios have been simulated or the search technique decides to stop searching, the PIP may then report the scenarios performing best with respect to the metric goal and constraints (block 374).

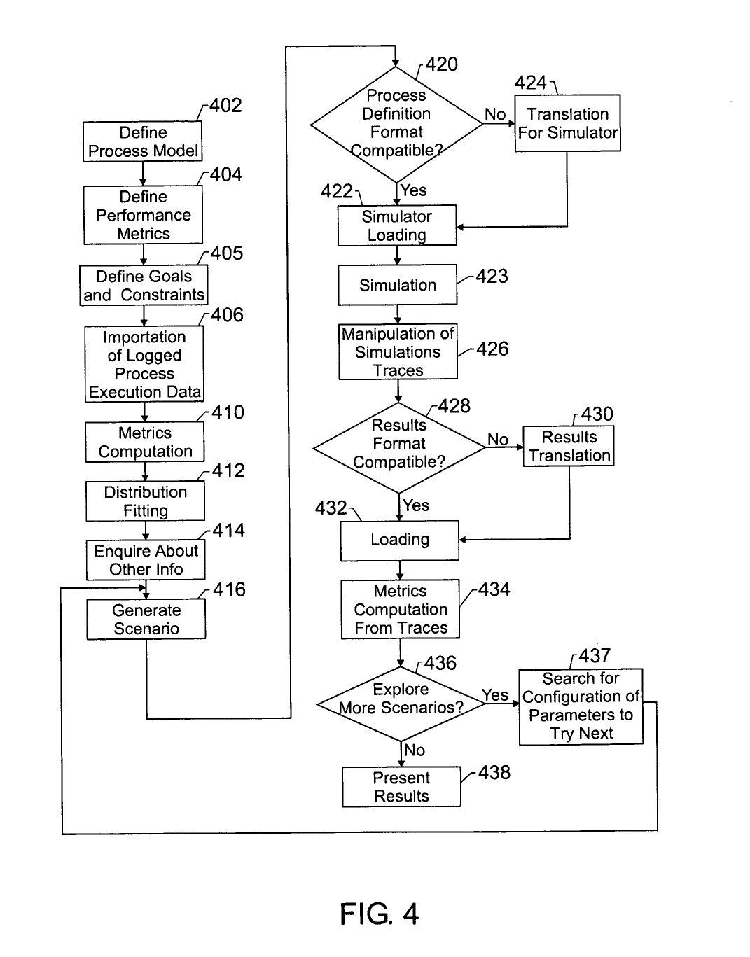

FIG. 4 is a block diagram illustrating a method in accordance with embodiments of the present invention. Specifically, FIG. 4 illustrates one embodiment of an operation method for a system such as the system 300 illustrated in FIG. 3. Accordingly, blocks 402 and 404 may represent a user defining a process model and performance metrics and goals for these metrics respectively. As discussed above, defining the process model may be accomplished using a process engine or a process-modeling tool.

After the user provides the definitions in blocks 402 and 404, the method proceeds to block 405. Block 405 represents the specification of goals and constraints each expressed in relationship to (in terms of) a metric. Block 406 represents importation of logged process execution data into a data warehouse. For example, as discussed previously regarding the system in FIG. 3, data logged during execution of a business operation may be imported into the data warehouse by an ETL tool. Block 410 represents computation of metrics from the real execution traces once the data is in the warehouse.

Block 412 represents distribution fitting of various aspects of process execution, which may be achieved by a PIE invoking a curve fitting tool that finds the probability distribution that best fits data of a particular aspect of a process. After computation of the distribution, the PIE may endow the process-modeling tool with distribution information and user requested information as illustrated by blocks 414-418. Specifically, block 414 represents enquiring a user or entity about other information for endowing the process-modeling tool. Block 416 represents generation of the scenario corresponding to the configuration determined by the search algorithm.

Next, the process may be loaded into a simulator as illustrated by blocks 420-424. Specifically, block 420 is a decision block representing a determination of whether acquired metadata that is to be loaded in a simulator (block 422) has a format that is compatible with the simulator. Metadata describes how and when and by whom a particular set of data was collected, and how the data is formatted. If the metadata is not compatible, the data is translated for the simulator in block 424 and then loaded in the simulator (block 422). However, if the metadata is compatible without being translated, it is loaded directly into the simulator (block 422). Once loaded, the simulation is carried out in block 423. Further, block 426 represents manipulation of simulation results such as execution traces that may be required when such traces are different from the real ones. For example, when traces are at a different granularity level than the real execution traces, or they lack end timestamps.

Blocks 428-432 represent storing data (e.g., execution traces and aggregated data) in the data warehouse. Accordingly, block 428 is a decision block representing a determination of whether the simulation results format is compatible with the data warehouse. If not, the results are translated as illustrated by block 430 and then loaded into the data warehouse as illustrated by block 432. If no translation is required, the data is directly loaded into the data warehouse (block 432).

After loading the data warehouse (block 432), metrics are computed from simulation traces (block 434) and the method proceeds in a conditional iteration illustrated by block 436. Block 436 is a decision block that represents exploring more scenarios to determine whether more scenarios are desired or required. If more scenarios are required, the method proceeds to block 437 to search which configuration of process parameters to try next, and the method continues. However, if there are no more scenarios, the results may be presented to a user or entity, as illustrated by block 438. These results may be the scenario that best meets the goals while satisfying the constraints.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for processing data, comprising:
a process-modeling tool adapted to define a process model, to define mapping from a resource to an activity in the process model, and to define a metric on the process model;
a designation module adapted to designate a goal and define constraints;
a process simulation engine adapted to employ the process model to simulate a process execution based on the process data according to different configurations and to produce process simulation data that comprises an expected value for the metric;
a process improvement engine adapted to evaluate the process simulation data produced by the process simulation engine and to provide process improvement data indicative of changes in the expected value of the metric; and
a search tool adapted to search a configuration space that comprises the process improvement data to determine a prospective configuration that causes the expected value of the metric to approach the goal.

2. The system of claim 1, comprising a statistical analysis tool for analyzing the process improvement data provided by the process improvement engine.

3. The system of claim 2, wherein the statistical analysis tool comprises a curve fitting tool.

4. The system of claim 1, wherein the process improvement engine is adapted to evaluate data produced by an actual execution of a process on which the process model is based.

5. The system of claim 1, comprising a manipulation module adapted to manipulate the process simulation data into a format compatible with the process improvement engine.

6. The system of claim 1, wherein the process simulation engine is adapted to employ the process model to simulate the process execution based on the process data according to the prospective configuration and to produce the process execution data that comprises the expected value for the metric based on the prospective configuration.

7. The system of claim 1, wherein the process simulation engine is adapted to provide an execution trace.

8. The system of claim 1, comprising an extraction tool adapted to extract logged process execution data into a data warehouse.

9. The system of claim 8, wherein the extraction tool is adapted to extract the logged process execution data into the data warehouse using a batch mode.

10. A processor-based method for processing data, comprising:
defining a process model, mapping from a resource to an activity in the process model, and defining a metric on the process model with a process-modeling tool;
designating a goal and defining constraints using a designation module;
simulating a process execution based on the process data produced by the process-modeling tool according to different configurations to produce process execution data that comprises an expected value for the metric;
evaluating the process simulation data produced by the process simulation engine with a process improvement engine adapted to and to provide process improvement data indicative of changes in the expected value of the metric; and
searching a configuration space that comprises the process improvement data to determine a prospective configuration that causes the expected value of the metric to approach a desired range.

11. The method of claim 10, comprising analyzing the process improvement data provided by the process improvement engine with a statistical analysis tool.

12. The method of claim 10, comprising analyzing the process improvement data provided by the process improvement engine with a curve fitting tool.

13. The method of claim 10, comprising evaluating data produced by an actual execution of a process on which the process model is based with the process improvement engine.

14. The method of claim 10, comprising manipulating the process simulation data to resemble real data with a manipulation module.

15. The method of claim 10, comprising providing an execution trace with the process simulation engine.

16. The method of claim 10, comprising an extraction tool adapted to extract logged process execution data into a data warehouse.

17. A computer program for processing data, comprising:
a tangible medium;
a process-modeling tool stored on the tangible medium, the process-modeling tool adapted to define a process model, to define mapping from resources to activities in the process model, and to define a metric on the process model;
a process simulation engine stored on the tangible medium, the process simulation engine adapted to employ the process model to simulate a process execution based on the process data according to different configurations and to produce process simulation data that comprises an expected value for the metric;
a process improvement engine stored on the tangible medium, the process improvement engine adapted to evaluate the process simulation data produced by the process simulation engine and to provide process improvement data indicative of changes in the expected value of the metric; and
a search tool stored on the tangible medium, the search tool adapted to search a configuration space to determine a prospective configuration.

18. The computer program of claim 17, comprising a statistical analysis tool stored on the tangible medium, the statistical analysis tool adapted for analyzing the process improvement data provided by the process improvement engine.

19. The computer program of claim 17, comprising a manipulation module stored on the tangible medium, the manipulation module adapted to manipulate the process simulation data to resemble real data.

20. The computer program of claim 17, wherein the process improvement engine is adapted to evaluate data produced by an actual execution of a process on which the process model is based.

21. The computer program of claim 17, comprising an extraction tool stored on the tangible medium, the extraction tool adapted to extract logged process execution data into a data warehouse.

22. The computer program of claim 21, wherein the extraction tool comprises a batch mode for extracting the logged process execution data into the data warehouse.

23. A system for processing data, comprising:
means for defining a process model, mapping from resources to activities in the process model, and defining a metric on the process model;
means for employing the process model to simulate a process execution based on the process data according to different configurations and to produce process simulation data that comprises an expected value for the metric;
means for evaluating the process simulation data produced by the process simulation engine and to provide process improvement data indicative of changes in the expected value of the metric; and
means for searching a configuration space to determine a prospective configuration.
